(19) United States
(12) Patent Application Publication
(10) Pub. No.: US 2007/0071026 A1
(43) Pub. Date: Mar. 29, 2007

(54) Compressed video packet scheduling system

(75) Inventor: Steven A. Rogers, Portsmouth, NH (US)

Correspondence Address: BANNER & WITCOFF, 1001 G STREET N W, SUITE 1100, WASHINGTON, DC, 20001, US

(73) Assignee: Rivulet Communications, Inc., Portsmouth, NH (US)

(21) Appl. No.: 11/233,144

(22) Filed: Sep. 23, 2005

(51) Int. Cl. H04L 12/43

(52) U.S. Cl. 370/458; 370/395.5

(57) ABSTRACT

A method of transmitting compressed video packets over a network includes steps of partitioning transmission interval into discrete time slots; sending scheduling packets over the network from the transmitting node to the receiving node; evaluating the response of the receiving node to determine reliability of the network at different time slots; and selecting one or more time slots for delivery of the compressed video packets according to the evaluation step. Other transmitters can similarly arrange to transmit during time slots not already allocated for the receiving node.

### CROSS-REFERENCE TO RELATED APPLICATIONS

The application is related in subject matter to U.S. patent application Ser. No. 10/663,378, filed Sep. 17, 2003 and titled “Empirical Scheduling of Network Packets,” and U.S. patent application Ser. No. 10/679,103, filed Oct. 31, 2003 and titled “Endpoint Packet Scheduling System.”

### BACKGROUND OF THE INVENTION

The present invention relates generally to a system for allowing devices connected to a network to transmit and receive compressed video data packets without impairment on the network.

Ethernet and packet-switched Internet Protocol (IP) networks are systems for transmitting data between different points. These systems are known as “contention-based” systems. That is, all transmitters contend for network resources. In such a system, multiple transmitters may transmit packets at such a time that the packets arrive at a network port simultaneously. When this happens, the network resources may become oversubscribed, resulting in lost or delayed data, and network impairment.

A conventional network comprises endpoints, such as computers, connected through a Local Area Network (LAN) or Wide Area Network (WAN). Packets are sent across the network from one endpoint to another, over packet-switching devices such as LAN switches or WAN routers. For example, in FIG. 1, a network is shown comprising a plurality of Local Area Network (LAN) endpoints connected to an Ethernet LAN. The endpoints are coupled to one or more LAN switches 102, which connect through another part of the network to one or more additional LAN endpoints 103. When endpoint 101 sends packets to endpoint 103, the packets are sent through LAN switch 102, which also handles packets from other LAN endpoints. If too many packets are simultaneously transmitted by the other endpoints to 103, LAN switch 102 may have a queue overflow, causing packets to be lost. (The word “packets” will be used to refer to datagrams in a LAN or Wide Area Network (WAN) environment. In a LAN environment, packets are sometimes called “frames.” In a packet-switched WAN environment, packet-switching devices are normally referred to as “routers.”).

FIG. 2 illustrates the nature of the problem of dropped packets, which can occur in a LAN environment as well as a WAN environment. During periods where multiple endpoints are simultaneously transmitting packets on the network, the LAN switch 102 may become overloaded, such that some packets are discarded. This is typically caused by an internal queue in the LAN switch becoming full and thus becoming unable to accept new packets until the outgoing packets have been removed from the queue. This creates a problem in that transmitting endpoints cannot be guaranteed that their packets will arrive, necessitating other solutions such as the use of guaranteed-delivery protocols such as Transmission Control Protocol (TCP). TCP is able to detect data loss and it causes retransmission of the data, until a perfect copy of the complete data file is delivered to the recipient device. However, many devices may be unable to use TCP or any retransmission method because it is far too slow.

Interactive video, interactive voice, and other real-time applications require delivery of data, accurately, the first time. Real-time video is comprised of a sequence of individual images, or video frames, which are sent in compressed form over the network and displayed in rapid succession by the receiver as they arrive. With real-time video or real-time voice applications, a receiver does not have to wait until a large file is downloaded before seeing the video or hearing the sound. Instead, the media is sent in a continuous stream and is played as it arrives. The receiver needs a player which is a special program that decompresses and sends video data to the display and audio data to the speakers. Real-time video is usually sent from pre-recorded video files, but can also be distributed as part of a live broadcast ‘feed’.

The DV compression standards are common formats used in real-time media applications. DV formats define digital video reduction and compression, used by applications that require real-time video capability over a network. In the DV formats, the video is divided into individual video frames and then compressed using a Discrete Cosine Transform. DV uses intraframe compression, meaning each compressed video frame depends entirely on itself, and not on any data from preceding or following video frames. However, it also uses adaptive interfield compression; if the compressor detects little difference between the two interlaced fields of a video frame, it will compress them together, freeing up some of the “bit budget” to allow for higher overall quality.

For real-time video applications using DV compressed video, high network traffic can cause connection, download and playback problems. When the player encounters high traffic, it degrades quality in an attempt to maintain continuous playback. For these applications to operate well, even the speed of light causes undesired delay. Thus, for DV real-time video applications, it is often not feasible use TCP or any method involving a retransmission delay.

The problem, therefore, is determining how to provide reliable, first-time delivery on a contention-based network. Various approaches have been tried. The most commonly proposed system relies on prioritization of data in the network. With this approach, data having real-time constraints is identified with priority coding so that it may be transmitted before other data.

Prioritization seems at first to be a good solution. However, on reflection it suffers from the same difficulty. Prioritization only provides a delivery advantage relative to the lower-priority data. It provides no advantage against the other priority data. Analysis and testing shows that this approach can work in certain circumstances, but only when the amount of priority data is small. When using prioritization with high-volume transmissions, such as real-time video applications, the amount of priority data is very high. Further, multiple video flows transmitting data at the same high priority level will contend with one another. Thus, in real-time video applications, prioritization will likely fail to prevent contention and packet loss.

Further, some networks and devices cannot support multiple priority levels for data packets. For example, some packet switches may support only one level of packet priority (i.e., two queues: one for prioritized packets and another for non-prioritized packets), making such a scheme difficult to implement.

Another approach is to multiplex the data. With this method the bursts of data associated with one flow of data are separated from the burst of another. Multiplexing usually uses some type of time-domain system (known as Time Domain Multiplexing (TDM)) to separate flows. TDM organizes the network so that specific time slots are assigned to individual flows. In other words, each potential transmitter on the network is guaranteed a slot of time to transmit, even if the transmitter is unlikely to use its assigned slot. These frequently unused time slots make TDM inefficient compared to Ethernet and IP networks.

Asynchronous Transfer Mode (ATM) is another technology for multiplexing a data network, to reduce contention. ATM breaks all data flows into equal length data blocks. Further, ATM can limit the number of data blocks available to any flow or application. The result is a virtual TDM multiplex system. ATM also has a limited address space, and thus is not as scalable to large networks as is Ethernet and IP.

Both TDM and ATM provide contention reduction, but at the cost of considerable added complexity, cost, components, and lost bandwidth performance. Other approaches rely on specialized hardware to schedule packet delivery, driving up hardware costs.

### SUMMARY OF THE INVENTION

The invention provides a method for transmitting compressed video packets in an Ethernet or IP packet network by scheduling them for delivery based on communications between the transmitting node and the receiving node, which are evaluated to determine a preferred delivery schedule.

In one variation, a transmitting node transmits a query to the intended receiving node, indicating the intent to transmit compressed video. The receiving node responds with a reception map indicating what transmission time slots have already been allocated by other transmitting nodes (or, alternatively, what transmission time slots are available). The transmitting node then proposes a transmission map to the receiving node, taking into account any time slots previously allocated to other transmitting nodes. The receiving node either accepts the proposed transmission map or proposes an alternate transmission map. Upon agreement between the nodes, the transmitting node begins transmitting the compressed video according to the proposed transmission map, and the receiving node incorporates the proposed transmission map into its allocation tables. Because the proposed delivery schedule has been agreed to between the two endpoints, uncoordinated contention that might otherwise overflow network switches near the endpoints is avoided. Because the schedule is determined by the two endpoints, no network arbiter is needed to coordinate among network resources.

In another variation, a transmitting node transmits the bandwidth requirement of the compressed video transmission to the intended recipient node. The intended recipient node, after evaluating time slots previously allocated to other transmitters, responds with a proposed delivery schedule indicating time slots during which the transmitter should transmit the compressed video packets in order to avoid contention with other previously scheduled packets while maintaining the necessary bandwidth for the transmitter. The transmitter thereafter transmits packets according to the proposed delivery schedule.

In another variation, a transmitting node transmits a proposed delivery schedule to an intended recipient, indicating time slots corresponding to times during which it proposes to transmit compressed video packets. The intended recipient either agrees to the proposed delivery schedule, or proposes an alternate delivery schedule that takes into account the transmitter's bandwidth requirements. Upon agreement between the nodes, transmission occurs according to the agreed-upon delivery schedule. The schedule can be released at the end of the transmission.

In yet another variation, a transmitting node having the need to transmit compressed video packets according to a known data rate transmits a series of test packets over the network to the intended receiver using different delivery times. The test packets are evaluated to determine which of the delivery times suffered the least latency and/or packet loss, and that delivery time is used to schedule the packets for the duration of the transmission. Other endpoints use a similar scheme, such that each endpoint is able to evaluate which delivery schedule is best suited for transmitting packets with the least likely packet loss and latency. Different priority levels are used to transmit the compressed video data; the test packets; and other data in the network.

### BRIEF DESCRIPTION OF THE DRAWINGS

FIG. 1 shows the problem of bursty packets creating an overflow condition at a packet switch, leading to packet loss.

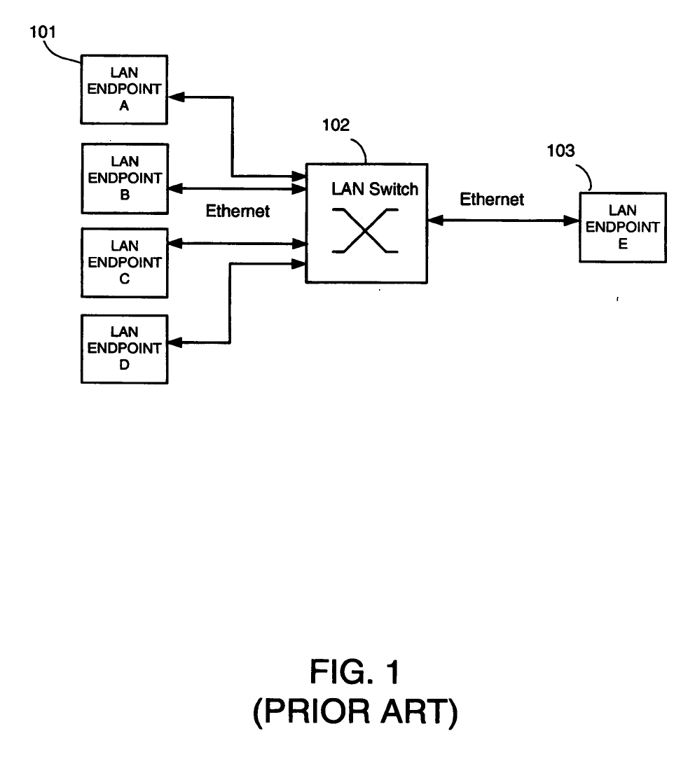

FIG. 2 shows how network congestion can cause packet loss where two sets of endpoints share a common network resource under bursty conditions.

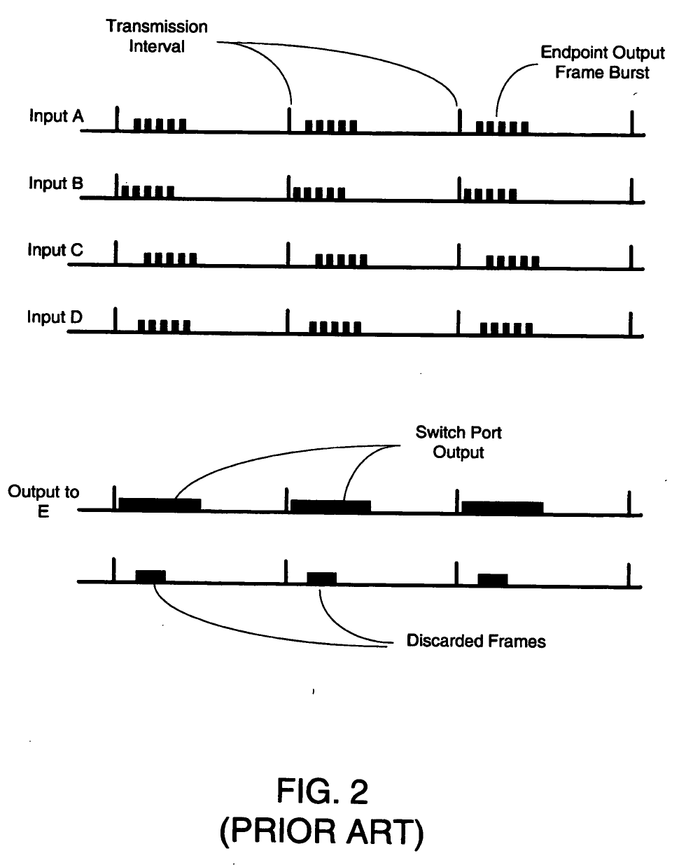

FIG. 3 shows one method for coordinating a delivery schedule for transmissions between a transmitting node and an intended recipient node.

FIG. 4 shows a second method for coordinating a delivery schedule for transmissions between a transmitting node and an intended recipient node.

FIG. 5 shows a third method for coordinating a delivery schedule for transmissions between a transmitting node and an intended recipient node.

FIG. 6 shows a fourth method, using test packets, for coordinating a delivery schedule for transmissions between a transmitting node and an intended recipient node.

FIG. 7 shows a system using a delivery schedule for test packets from a first endpoint to a second endpoint.

FIG. 8 shows a frame structure in which a transmission interval can be decomposed into a master frame; subframes; and secondary subframes.

FIG. 9 shows one possible reception map for a given transmission interval.

FIG. 10 shows a scheme for time synchronizing delivery schedules among network nodes.

FIG. 11 shows an alternative scheme for time synchronizing delivery schedules among network nodes.

FIG. 12 shows how network congestion is avoided through the use of the inventive principles, leading to more efficient scheduling of packets in the network.

FIG. 13 shows communication between a transmitter and receiver through a network.

FIG. 14 shows how two endpoints can refer to a time interval specified with reference to frames that have a different phase but which are referenced to a common clock.

### DETAILED DESCRIPTION OF THE INVENTION

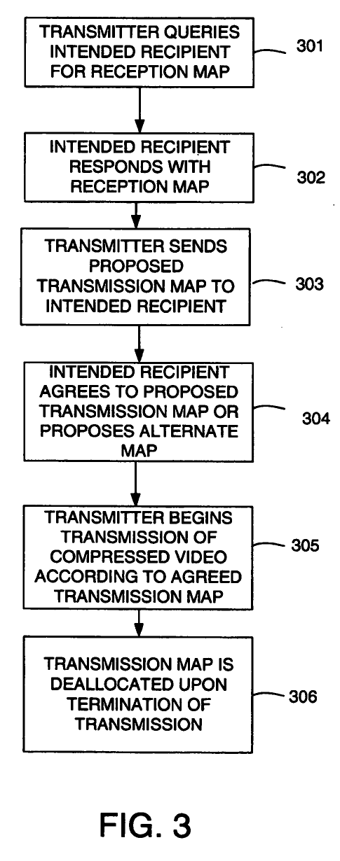

FIGS. 3-6 show different methods for carrying out the principles of the invention. Before describing these methods, it is useful to explain how packets are scheduled for delivery over the network between nodes according to the invention.

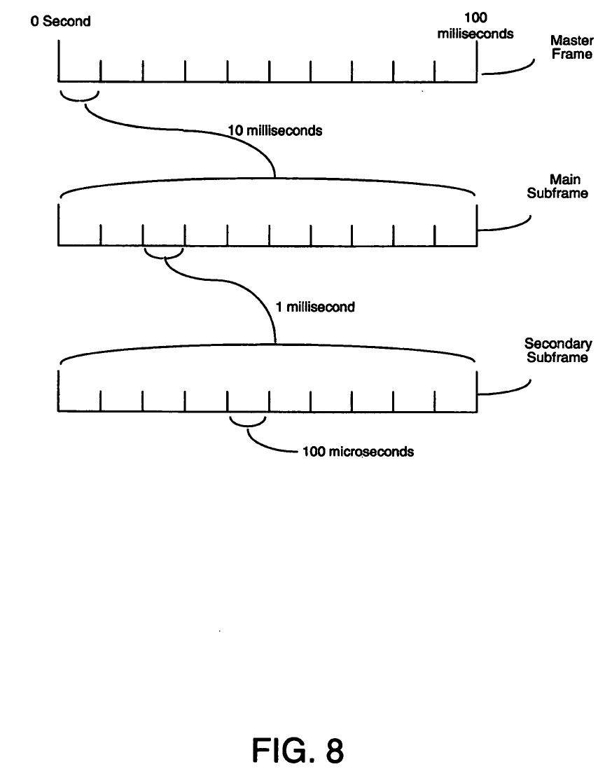

Turning briefly to FIG. 8, a transmission interval is partitioned into units and (optionally) subunits of time during which data packets can be transmitted. In the example of FIG. 8, an arbitrary transmission interval of one hundred milliseconds (a master frame) can be decomposed into subframes each of 10 millisecond duration, and each subframe can be further decomposed into secondary subframes each of 1 millisecond duration. Each secondary subframe is in turn divided into time slots of 100 microsecond duration. Therefore, a period of 100 milliseconds would comprise 1,000 slots of 100 microseconds duration. According to one variation of the invention, the delivery time period for each unit of transmission bandwidth to a receiving node is decomposed using a scheme such as that shown in FIG. 8, and packets are assigned for transmission to time slots according to this schedule. This scheme is analogous to time-division multiplexing (TDM) in networks.

Depending on the packet size and underlying network bandwidth, some varying fraction of each time slot would be actually used to transmit a packet. Assuming a packet size of 125 bytes (1,000 bits) and a 10BaseT Ethernet operating at 10 mbps, a single 100-microsecond time slot would be used to transmit each packet. Assuming a packet size of 1,500 bytes, twelve of the 100-microsecond intervals would be consumed by each packet transmission.

According to one variation of the invention, the scheduled delivery scheme applies to prioritized packets in the network; other non-prioritized packets are not included in this scheme. Therefore, in a system that supports only priority traffic and non-priority traffic, the scheduled delivery scheme would be applied to all priority traffic, and ad-hoc network traffic would continue to be delivered on a nonpriority basis. In other words, all priority traffic would be delivered before any nonpriority traffic is delivered.

The delivery schedule of FIG. 8 is intended to be illustrative only; other time period schemes can be used. For example, it is not necessary to decompose a transmission interval into subframes as illustrated; instead, an arbitrary interval can be divided up into 100-microsecond time slots each of which can be allocated to a particular transmitting node. Other time periods could of course be used, and the invention is not intended to be limited to any particular time slot scheme. The delivery schedule can be derived from a clock such as provided by a Global Positioning System (GPS), a radio time source, or another network synchronization method. The means by which time slots are synchronized in the network is discussed in more detail below.

The methods taught by the invention may apply to real-time video compressed with DV compression standards. This standard, which includes the DV25, DV50, DV100, MPEG, and H260 variants, etc., is a common format for digital video reduction and compression. Under the DV standards, before video is transmitted over the network to the receiver, the video is divided into video frames and then compressed using a Discrete Cosine Transform. The DV standards use intraframe compression, meaning each compressed video frame depends entirely on itself, and not on any data from preceding or following video frames. However, they also use adaptive interfield compression. That is, if the DV compressor detects little difference between the two interlaced fields of a video frame, it will compress them together, freeing up some of the “bit budget” to allow for higher overall quality.

One example of a DV standard is the DV25. Under the DV25 format, video information is carried in a nominal 25 megabit per second (Mbits/sec) data stream. After adding in audio, subcode (including timecode), Insert and Track Information (ITI), and error correction, the total data stream transmits about 30 Mbits/sec.

Suppose that a transmitting node needs to support a real-time video connection over the network. For a single real-time video connection transmitting DV25 compressed video, a bandwidth of 30 Mbits/second might be needed. Assuming a packet size of 2048 bytes, or 16,384 bits, this would mean that approximately 1,800 packets per second must be transmitted, which works out to (on average) two packets every millisecond. In the example of FIG. 8, this would mean transmitting a packet during at least two of the time slots in every secondary subframe at the bottom of the figure.

Returning to FIG. 3, in step 301, a transmitting node sends a query to an intended receiving node in the network for a reception map.

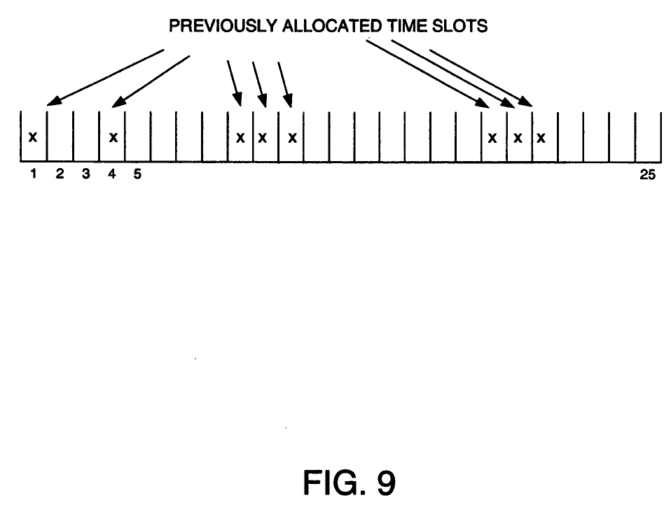

In one embodiment, a reception map (see FIG. 9) is used to indicate time slots that have already been allocated to other transmitters for reception by the receiving node (or, alternatively, time slots that have not yet been allocated, or, alternatively, time slots that are candidates for transmission). More generally, a reception map is a data structure that indicates—in one form or another—time slots during which transmission to the intended receiving node would not conflict with other transmitters. Although there are many ways of representing such a map, one approach is to use a bitmap wherein each bit corresponds to one time slot, and a “1” indicates that the time slot has been allocated to a transmitting node, and a “0” indicates that the time slot has not yet been allocated. FIG. 9 thus represents 25 time slots of a delivery schedule, and certain time slots (indicated by an “x” in FIG. 9) have already been allocated to other transmitters. If a 100-millisecond delivery interval were divided into 100-microsecond time slots, there would be 1,000 bits in the reception map. This map could be larger, for higher bandwidths. For instance, for a 100 megabit per second link, the map could have 10,000 bits, etc., to represent the same throughput per slot.

In step 302, the intended receiving node responds with a reception map such as that shown in FIG. 9, indicating which time slots have already been allocated to other transmitters. If this were the first transmitter to transmit to that receiving node, the reception map would be empty. It is of course also possible that time slots could have been previously allocated to the same transmitter to support an earlier transmission (i.e., the same transmitter needs to establish a second connection to the same recipient).

In step 303, the transmitter sends a proposed transmission map to the intended receiving node. The proposed transmission map preferably takes into account the allocated time slots received from the intended receiving node, so that previously allocated time slots are avoided. The transmitter allocates enough time slots to support the required bandwidth of the transmission while avoiding previously allocated time slots.

In step 304, the intended recipient reviews the proposed transmission map and agrees to it, or proposes an alternate transmission map. For example, if the intended recipient had allocated some of the proposed time slots to another transmitter during the time that the transmitter was negotiating for bandwidth, the newly proposed delivery schedule might present a conflict. In that situation, the intended recipient might propose an alternate map that maintained the bandwidth requirements of the transmitter.

In step 305, the transmitter repeatedly transmits packets, or bursts of packets, to the intended recipient according to the agreed delivery schedule, each packet containing a compressed video frame or video frame portion. To support a real-time video connection, for example, the transmitter could transmit six 80-byte packets every 10 milliseconds. For a higher definition real-time video connection, the transmitter could transmit at a more frequent rate. Finally, in step 306 the receiver's map is deallocated when the transmitter no longer needs to transmit.

Note that for two-way communication, two separate connections can be established: one for node A transmitting to node B, and another connection for node B transmitting to node A. Although the inventive principles will be described with respect to a one-way transmission, it should be understood that the same steps would be repeated at the other endpoint where a two-way connection is desired.

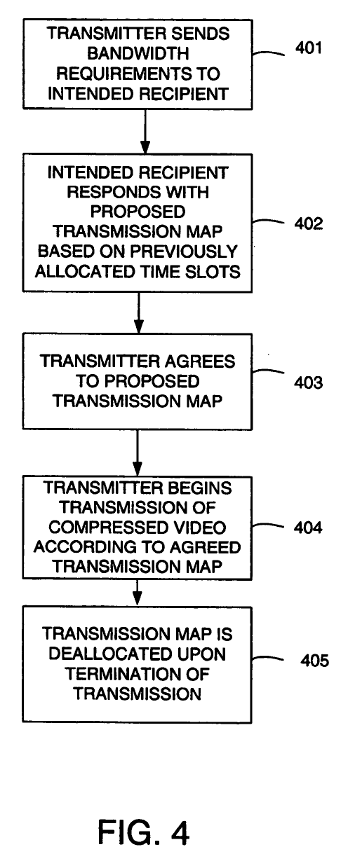

FIG. 4 shows an alternative method for carrying out the inventive principles. Beginning in step 401, the transmitter sends a bandwidth requirement to the intended recipient. For example, the transmitter may dictate a packet size and bandwidth, and the intended recipient could determine which slots should be allocated to support that bandwidth. In step 402, the intended recipient responds with a proposed transmission map that takes into account previously allocated time slots.

In step 403, the transmitter agrees to the proposed transmission map, causing the intended receiver to “lock in” the agreed time slots (this step could be omitted), and in step 404 the transmitter transmits packets according to the agreed-upon schedule. Finally, in step 405 the transmission map is deallocated upon termination of the connection.

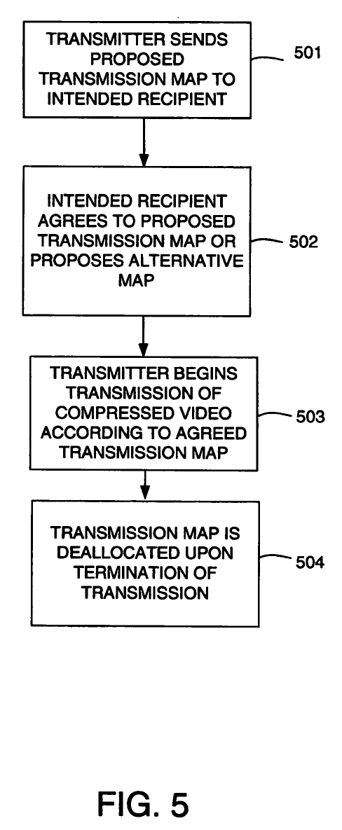

FIG. 5 shows another variation of the inventive method. In step 501, the transmitting node sends a proposed transmission map to the intended recipient. In step 502, the intended recipient either agrees to the proposed transmission map (if it is compatible with any previously-allocated maps) or proposes an alternative map that meets the transmitter's bandwidth requirements, which can be inferred from the proposed transmission map. For example, if the transmitter had proposed transmitting in time slots 1, 11, 21, 31, 41, and so forth, it would be evident that the transmitter needed to transmit once every tenth time slot. If the requested slots were not available, the intended recipient could instead propose slots 2, 12, 22, 32, and so forth.

In step 503, the transmitter transmits packets containing compressed video frames according to the agreed-upon delivery schedule, and in step 504 the transmission map is deallocated upon termination of the transmission.

In another variation, a transmitter may request bandwidth (e.g., one 1000-byte packet every 10 milliseconds) and the receiver responds with a placement message (e.g., start it at the 75th 100-microsecond slot). The receiver could also respond with multiple alternatives (e.g., start it at the 75th, the 111th, or the 376th time slot). The transmitter would respond with the time slot that it intended to use (e.g., the 111th), and begin transmission. This variation is intended to be within the scope of sending “transmission maps” and “reception maps” as those terms are used herein.

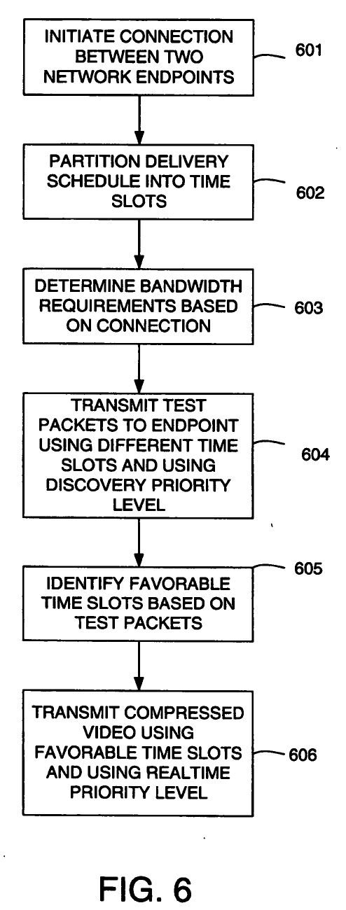

FIG. 6 shows another variation of the inventive method. Beginning in step 601, a determination is made that two endpoints on the network (e.g., an Ethernet network or an IP network) desire to communicate. This determination may be the result of a telephone receiver being picked up and a telephone number being dialed, indicating that two nodes need to initiate a connection suitable for compressed video. Alternatively, a one-way connection may need to be established between a node that is transmitting video data and a receiving node. Each of these connection types can be expected to impose a certain amount of data packet traffic on the network.

In step 602, as described in the above embodiments, a delivery schedule is partitioned into time slots according to a scheme such as that illustrated in FIG. 8. Note, this step can be done in advance and need not be repeated every time a connection is established between two endpoints. In step 603, as described in the above embodiments, the required bandwidth between the two endpoints is determined. For example, for a single real-time video connection, a bandwidth of 400 kilobits per second might be needed. Assuming a packet size of 480 bytes or 3840 bits (ignoring packet overhead for the moment), this would mean that approximately 100 packets per second must be transmitted, which works out to (on average) a packet every 10 milliseconds.

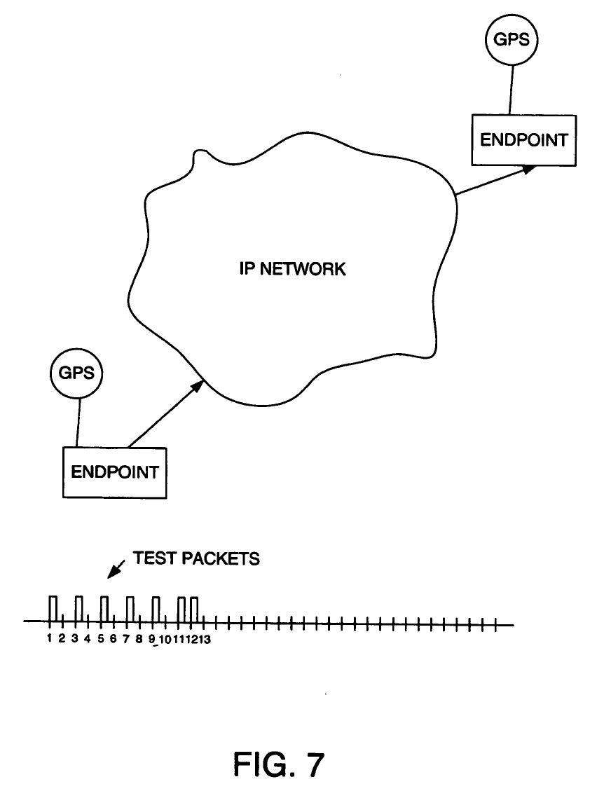

In step 604, a plurality of test packets are transmitted during different time slots at a rate needed to support the desired bandwidth. Each test packet is transmitted using a “discovery” level priority that is higher than that accorded to normal data packets (e.g., TCP packets) but lower than that assigned to real-time data traffic (to be discussed below). For example, turning briefly to FIG. 7, suppose that the schedule has been partitioned into one millisecond time slots. The test packets might be transmitted during time slots 1, 3, 5, 7, 9, 11, and 12 as shown. Each test packet preferably contains the “discovery” level priority; a timestamp to indicate when the packet was sent; a unique sequence number from which the packet can be identified after it has been transmitted; and some means of identifying what time slot was used to transmit the packet. (The time slot might be inferred from the sequence number). The receiving endpoint upon receiving the test packets returns the packets to the sender, which allows the sender to (a) confirm how many of the sent packets were actually received; and (b) determine the latency of each packet. Other approaches for determining latency can of course be used. The evaluation can be done by the sender, the recipient, or a combination of the two.

In step 605, the sender evaluates the test packets to determine which time slot or slots are most favorable for carrying out the connection. For example, if it is determined that packets transmitted using time slot #1 suffered a lower average dropped packet rate than the other slots, that slot would be preferred. Similarly, the time slot that resulted in the lowest packet latency (round-trip from the sender) could be preferred over other time slots that had higher latencies. The theory is that packet switches that are beginning to be stressed would have queues that are beginning to fill up, causing increases in latency and dropped packets. Accordingly, according to the inventive principles other time slots could be used to avoid transmitting packets during periods that are likely to increase queue lengths in those switches. In one variation, the time slots can be “overstressed” to stretch the system a bit. For example, if only 80-byte packets are actually needed, 160-byte packets could be transmitted during the test phase to represent an overloaded condition. The overloaded condition might reveal bottlenecks where the normal 80-byte packets might not.

Rather than the recipient sending back time-stamped packets, the recipient could instead perform statistics on collected test packets and send back a report identifying the latencies and dropped packet rates associated with each time slot.

As explained above, packet header overhead has been ignored but would typically need to be included in the evaluation process (i.e., 80-byte packets would increase by the size of the packet header). Slot selection for the test packets could be determined randomly (i.e., a random selection of time slots could be selected for the test packets), or they could be determined based on previously used time slots. For example, if a transmitting node is already transmitting on time slot 3, it would know in advance that such a time slot might not be a desirable choice for a second connection. As another example, if the transmitting node is already transmitting on time slot 3, the test packets could be transmitted in a time slot that is furthest away from time slot 3, in order to spread out as much as possible the packet distribution.

In step 606, a connection is established between the two endpoints and packets are transmitted using the higher “real-time” priority level and using the slot or slots that were determined to be more favorable for transmission. Because the higher priority level is used, the connections are not affected by test packets transmitted across the network, which are at a lower priority level. In one variation, the IP precedence field in IP packet headers can be used to establish the different priority levels.

FIG. 7 shows a system employing various principles of the invention. As shown in FIG. 7, two endpoints each rely on a GPS receiver for accurate time clock synchronization (e.g., for timestamping and latency determination purposes). The IP network may be comprised of a plurality of routers and/or other network devices that are able to ultimately route packets (e.g., IP or Ethernet packets) from one endpoint to the other. It is assumed that the organization configuring the network has the ability to control priority levels used on the network, in order to prevent other nodes from using the discovery priority level and real-time priority level. As mentioned above, the invention is not limited to GPS receivers to perform time clock synchronization. A radio time source or other network synchronization method may be used.

It should be appreciated that rather than transmitting test packets simultaneously during different time slots, a single slot can be tested, then another slot, and so on, until an appropriate slot is found for transmission. This would increase the time required to establish a connection. Also, as described above, for a two-way connection, both endpoints would carry out the steps to establish the connection.

In another variation, packet latencies and dropped packet rates can be monitored during a connection between endpoints and, based on detecting a downward trend in either parameter, additional test packets can be transmitted to find a better time slot in which to move the connection.

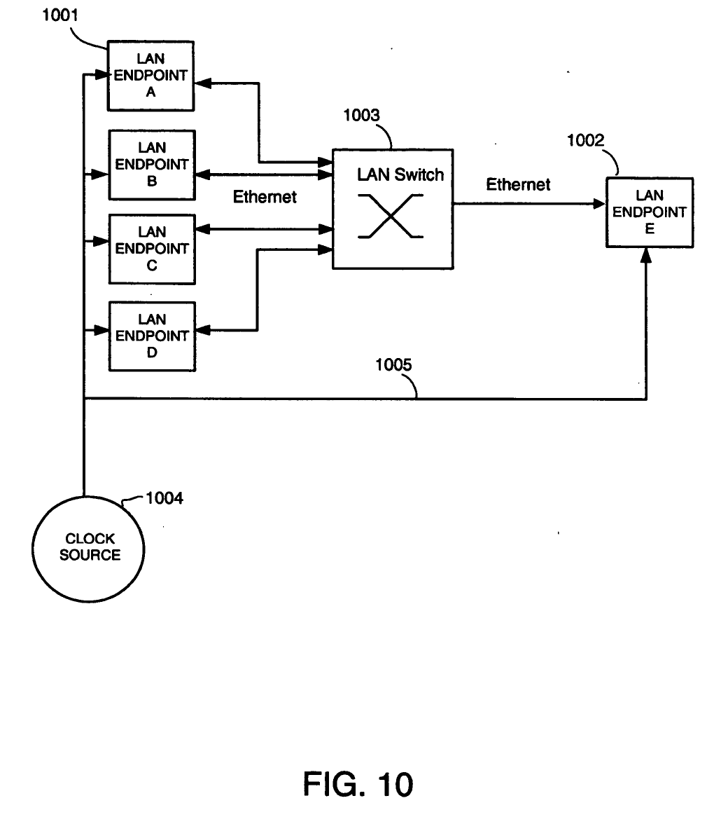

As shown in FIG. 10, the network comprises various endpoints 1001-1002 connected through a switch 1003. According to one variation of the invention, a GPS clock source 1004 is coupled through an electrical wire 1005 to each network node participating in the scheduled delivery scheme. The GPS clock source 1004 generates pulses that are transmitted to each node and used as the basis for the delivery schedule. Each node may comprise a timer card or other mechanism (e.g., an interrupt-driven operating system) that is able to use the timing signals to establish a common reference frame. This means synchronizing may therefore comprise a physical wire (separate and apart from the network) over which a synchronization signal is transmitted to each node. It may further comprise a hardware card and/or software in each node to detect and decode the synchronization signal. Wire 1005 may comprise a coaxial cable or other means of connecting the clock source to the nodes. In one variation, this wire is of a short enough distance (hundreds of feet) so that transmission effects and delays are avoided.

The clock pulses may comprise a pulse according to an agreed-upon interval (e.g., one second) that is used by each node to generate time slots that are synchronized to the beginning of the pulses. Alternatively, the clock source may generate a high-frequency signal that is then divided down into time slots by each node. Other approaches are of course possible.

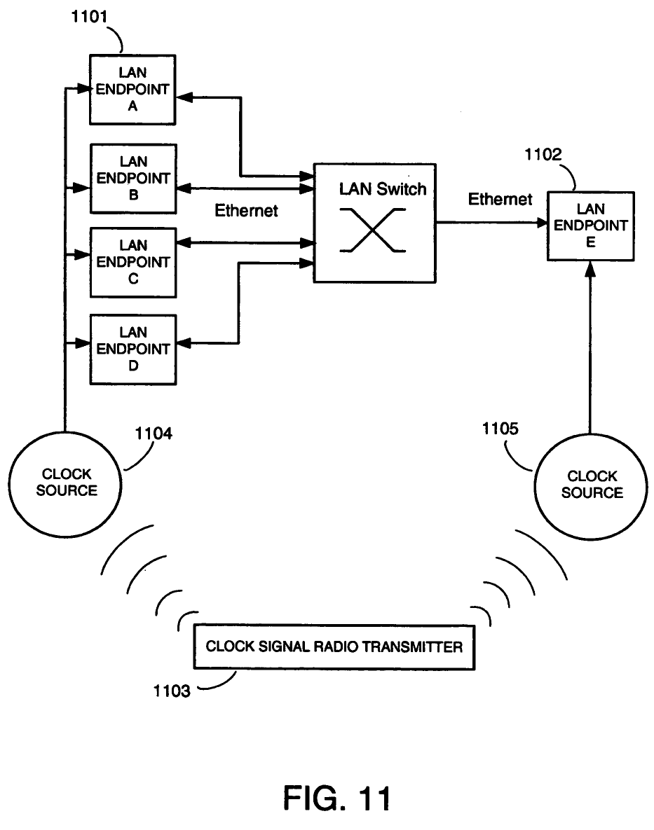

As another alternative, each clock source may be synchronized to a common reference signal, such as a radio signal transmitted by the U.S. Government. As shown in FIG. 11, various endpoints 1101-1102 are connected to clock sources 1104-1105, respectively. Each clock source comprises a radio receiver and delivers time synchronization information to the endpoint nodes based on periodic signals received from a clock signal radio transmitter 1103.

Another way or means of synchronizing time slots and delivery schedules among the nodes is to have one node periodically transmit (e.g., via multicast) a synchronization packet on the node on the network. Each node would receive the packet and use it to synchronize an internal clock for reference purposes. As an alternative to the multicast approach, one network node can be configured to individually send synchronization packets to each participating network node, taking into account the stagger delay involved in such transmission. For example, a synchronization node would transmit a synchronization packet to a first node on the network, then send the same packet to a second node on the network, which would be received later by the second node. The difference in time could be quantified and used to correct back to a common reference point. Other approaches are of course possible, and any of these means for synchronizing may be used independently of the others.

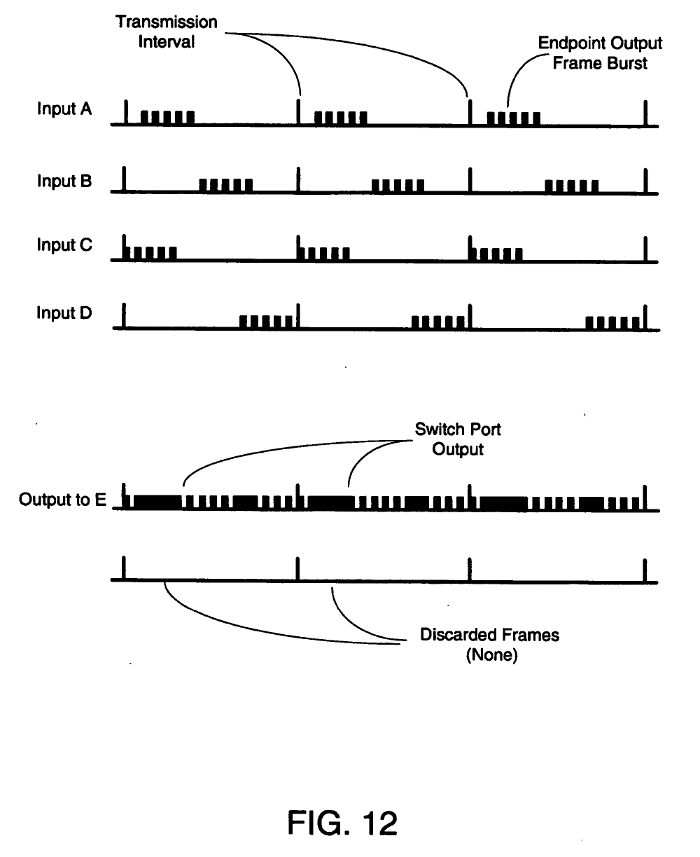

FIG. 12 illustrates how practicing the inventive principles can reduce congestion by more efficiently scheduling compressed video data packets between transmitters and receivers. As shown in FIG. 12, because each transmitting node schedules packets for delivery during times that do not conflict with those transmitted by other nodes, no packets are lost.

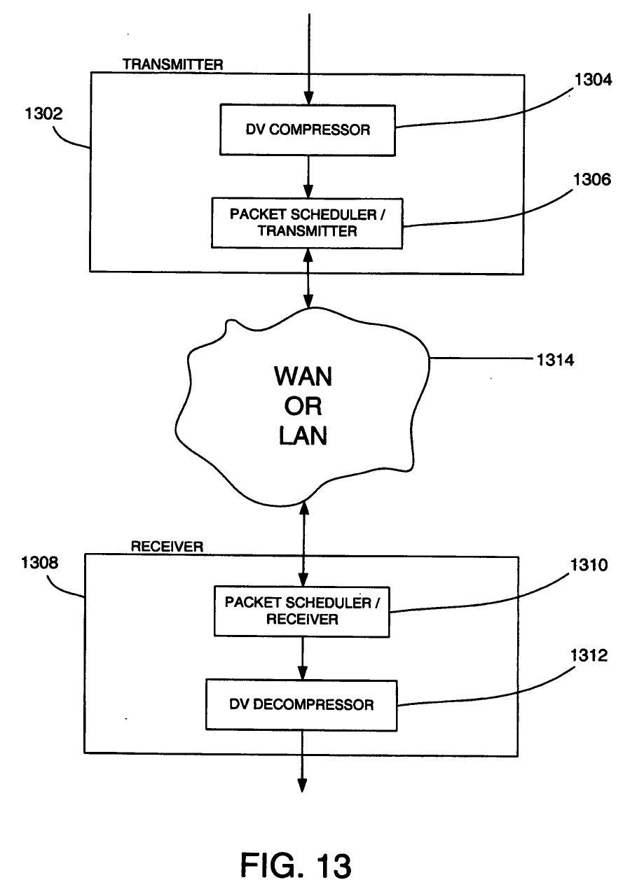

FIG. 13 illustrates communications that may take place between the transmitter, the receiver, and their subcomponents. In one embodiment, the transmitting node 1302 contains a DV compressor 1304 and packet scheduler/transmitter 1306. The receiving node 1308 contains a packet scheduler/receiver 1310 and a DV uncompressor 1312. To send a compressed video transmission, the transmitting node 1302 compresses the video file using its internal DV compressor 1304. The transmitter's packet scheduler/transmitter 1306 transmits and receives communications from the receiver's packet scheduler/receiver 1310 over the LAN or WAN 1314, and then evaluates this communication to determine the preferred time slots for sending the compressed video. The various methods of communications between the packet schedulers, and methods to determine the preferred time slots are discussed in detail above. Finally, the transmitter's packet scheduler/transmitter 1306 will send the compressed video packets over the LAN or WAN network 1314, according to the determined transmission schedule.

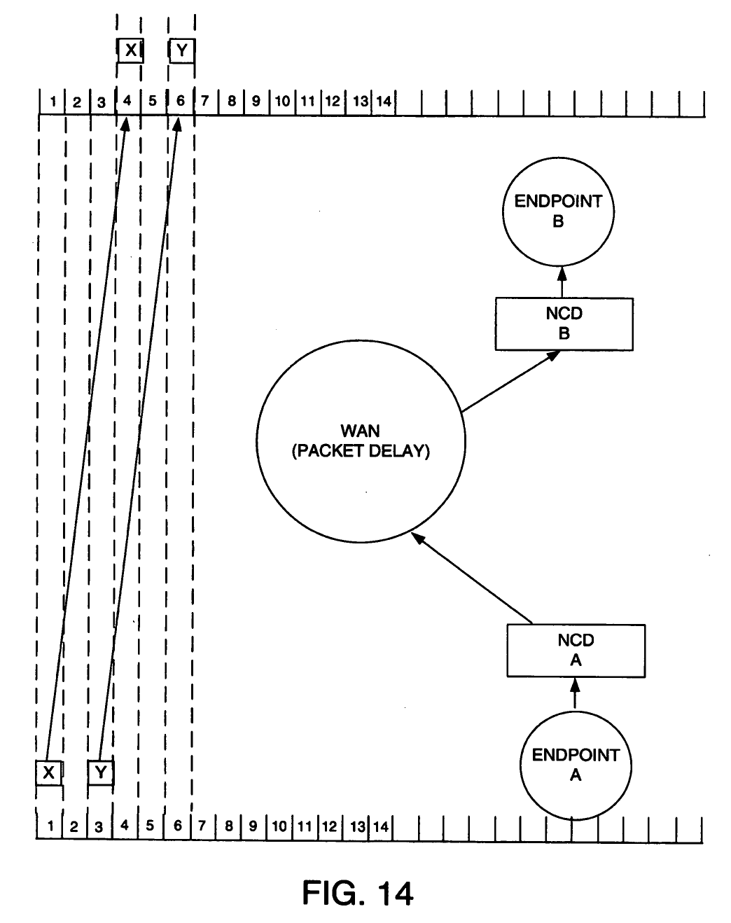

It should be understood that the phase of all frames may be independent from one another; they need only be derived from a common clock. Different endpoints need not have frames synchronized with each other. In other words, each time interval need not be uniquely identified among different endpoints, as long as the time intervals remain in relative synchronicity. This principle is shown with reference to FIG. 14, which shows how two endpoints can refer to a time interval specified with reference to frames that have a different phase but which are referenced to a common clock. (It is not necessary that the endpoints actually be synchronized to a common clock, although FIG. 14 shows this for each of understanding).

As shown in FIG. 14, suppose that endpoint A (bottom of FIG. 14) needs to communicate with endpoint B (top of FIG. 14) through a WAN that introduces a packet delay. Each endpoint has an associated network connection device (NCD) that handles the connection with the WAN. Suppose also that the timeline across the top of FIG. 14 and the timeline across the bottom of FIG. 13 represent “absolute” time; i.e., time interval 1 at the top of FIG. 14 appears at the same instant in absolute time as time interval 1 at the bottom of FIG. 14. Suppose further that NCD A transmits a first test packet X across the network during interval 1 and a second test packet Y across the network during interval 3. Due to the packet delay introduced by the WAN, test packet X will not arrive at endpoint B until what endpoint B perceives to be time interval 4. Similarly, test packet Y will not arrive at endpoint B until what endpoint B perceives to be time interval 6. Yet endpoints A and B (through their respective network connection devices NCD A and NCD B) need to agree on what time interval future packets will be transmitted.

In short, when NCD B determines that test packet X was received with minimal delay, it informs NCD A that the test packet identified as “packet X” was empirically favorable for future transmissions. Thus, NCD A identifies the relevant time interval as interval 1, whereas NCD B identifies the relevant time interval as interval 4. Similarly, NCD A identifies the relevant time interval for packet Y as interval 3, whereas NCD B identifies the relevant time interval for packet Y as interval 6. As long as the timeline at the top of FIG. 14 and the timeline at the bottom of FIG. 14 do not move relative to each other, the system can accommodate packet delays and endpoints can agree on what time interval locations should be used to transmit packets. Other approaches can of course be used.

The invention will also work with “early discard” settings in router queues since the empirical method would detect that a discard condition is approaching.

While the invention has been described with respect to specific examples including presently preferred modes of carrying out the invention, those skilled in the art will appreciate that there are numerous variations and permutations of the above described systems and techniques that fall within the spirit and scope of the invention as set forth in the appended claims. Any of the method steps described herein can be implemented in computer software and stored on computer-readable medium for execution in a general-purpose or special-purpose computer, and such computer-readable media is included within the scope of the intended invention. The invention extends to not only the method but also to computer nodes programmed to carry out the inventive principles. Numbering associated with process steps in the claims is for convenience only and should not be read to imply any particular ordering or sequence.

I claim:

1. A method of transmitting compressed video packets over a computer network, comprising the steps of:
(1) from a transmitting node, transmitting a scheduling request to an intended receiving node;
(2) receiving from the intended receiving node a response to the transmitted scheduling request;
(3) evaluating said response to determine time slots during which transmission to the intended receiving node would not conflict with other transmitters; and
(4) from the transmitting node, transmitting compressed video packets to the intended receiving node using the time slots evaluated in step (3).

2. The method of claim 1, wherein the compressed video packets are compressed according to a DV compression standard.

3. The method of claim 1, wherein step (1) comprises transmitting a query to the intended receiving node.

4. The method of claim 1, wherein step (1) comprises transmitting a bandwidth requirement to the intended receiving node.

5. The method of claim 1, wherein step (1) comprises transmitting a proposed delivery schedule to the intended receiving node.

6. The method of claim 5, wherein the proposed delivery schedule is a transmission map.

7. The method of claim 1, wherein step (1) comprises transmitting a plurality of test packets over the network during a plurality of different time slots, and step (2) comprises receiving a response consisting of returned packets corresponding to said transmitted test packets.

8. The method of claim 7, wherein step (3) comprises evaluating a dropped packet rate associated with said returned packets.

9. The method of claim 7, wherein step (3) comprises evaluating packet latencies associated with said returned packets.

10. The method of claim 1, wherein the compressed video packets comprise Internet Protocol (IP) packets transmitted over a packet-switched network.

11. The method of claim 1, wherein the computer network comprises an Ethernet.

12. The method of claim 1, further comprising the step of periodically synchronizing, as between the transmitting node and the receiving node, a time period on which the time slots are based.

13. The method of claim 1, wherein step (2) comprises receiving from the intended receiving node a reception map.

14. A computer programmed with executable instructions that, when executed, perform the following steps:
(1) transmitting from a transmitting node a scheduling request to an intended receiving node;
(2) receiving from the intended receiving node a response to the transmitted scheduling request;
(3) evaluating said response to determine time slots during which transmission to the intended receiving node would not conflict with other transmitters; and
(4) from the transmitting node, transmitting compressed video packets to the intended receiving node using the time slots evaluated in step (3).

15. The computer according to claim 14, wherein the compressed video packets are compressed according to the DV compression standard.

16. The computer according to claim 14, wherein step (1) comprises transmitting a query to the intended receiving node.

17. The computer according to claim 14, wherein step (1) comprises transmitting a bandwidth requirement to the intended receiving node.

18. The computer according to claim 14, wherein step (1) comprises transmitting a proposed delivery schedule to the intended receiving node.

19. The computer according to claim 18, wherein the proposed delivery schedule is a transmission map.

20. The computer according to claim 14, wherein step (1) comprises transmitting a plurality of test packets over the network during a plurality of different time slots, and step (2) comprises receiving a response consisting of returned packets corresponding to said transmitted test packets.

21. The computer according to claim 20, wherein step (3) comprises evaluating a dropped packet rate associated with said returned packets.

22. The computer according to claim 20, wherein step (3) comprises evaluating packet latencies associated with said returned packets.

23. The computer according to claim 14, further comprising the step of periodically synchronizing, as between the transmitting node and the receiving node, a time period on which the proposed time slots are based.

24. The computer according to claim 14, wherein step (2) comprises receiving from the intended receiving node a reception map.

25. An apparatus for transmitting compressed video packets over a computer network, comprising:
a video compressor; and
a packet scheduler and transmitter that transmits a scheduling request to an intended receiving node, receives a response from said intended receiving node to the transmitted scheduling request, evaluates said response to determine time slots during which transmission to the intended receiving node would not conflict with other transmitters, and transmits compressed video packets to the intended receiving node using said time slots.

26. The apparatus of claim 25, wherein the video compressor is a DV compressor.

27. The apparatus of claim 25, wherein the packet scheduler and transmitter transmits a query to the intended receiving node.

28. The apparatus of claim 25, wherein the packet scheduler and transmitter transmits a bandwidth requirement to the intended receiving node.

29. The apparatus of claim 25, wherein the packet scheduler and transmitter transmits a proposed delivery schedule to the intended receiving node.

30. The apparatus of claim 29, wherein the proposed delivery schedule is a transmission map.

31. The apparatus of claim 25, wherein the packet scheduler and transmitter transmits a plurality of test packets over the network to the intended receiving node during a plurality of different time slots, and receives a response consisting of returned packets corresponding to said transmitted test packets.

32. The apparatus of claim 31, wherein the packet scheduler and transmitter evaluates a dropped packet rate associated with said returned packets.

33. The apparatus of claim 31, wherein the packet scheduler and transmitter evaluates packet latencies associated with said returned packets.

34. The apparatus of claim 25, further comprising a clock that periodically synchronizes, as between the transmitting node and the receiving node, a time period on which the proposed time slots are based.
